(19) United States
(12) Patent Application Publication
(10) Pub. No.: US 2008/0309684 A1
(43) Pub. Date: Dec. 18, 2008

(54) DISPLAY DRIVING DEVICE, DISPLAY DEVICE, AND ELECTRONIC APPARATUS

(75) Inventor: Munenori SAWADA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/057,857

(22) Filed: Mar. 28, 2008

(30) Foreign Application Priority Data
Mar. 29, 2007 (JP) 2007-086776

(51) Int. Cl. G09G 5/10

(52) U.S. Cl. 345/690

(57) ABSTRACT

A display driving device for driving a display device having a plurality of display pixels in which a plurality of scanning electrodes and a plurality of data electrodes are provided so as to overlap and correspond to each other and each of which has an electro-optical layer to which driving voltages corresponding to a data voltage and a scanning voltage are applied when the scanning voltage is applied to the scanning electrodes and the data voltage is applied to the data electrodes is disclosed. The device includes: a temperature detecting unit that detects the temperature of the display device; a selection phase setting unit that sets a time interval of a selection phase, in which a driving voltage for selecting gray-scale levels of the display pixels is applied, to a time interval based on a detected temperature when the detected temperature detected by the temperature detecting unit is less than a predetermined temperature and sets a time interval of the selection phase to a fixed time when the detected temperature is equal to or larger than the predetermined temperature; and a voltage applying unit that applies the driving voltage to the display pixels at the time interval set by the selection phase setting unit.

### BACKGROUND

1. Technical Field

The present invention relates to a technique of performing image display by using cholesteric liquid crystal having a storage property that preserves display contents at time of non-supply of electric power.

2. Related Art

There is a DDS (dynamic drive scheme) method as a driving method for a cholesteric liquid crystal panel that performs image display by changing an alignment state of cholesteric liquid crystal described in U.S. Pat. No. 5,748,277. In a liquid crystal driving circuit that performs such DDS, it is general that bit-map data of an image to be displayed is read sequentially for every line according to a read clock signal. In addition, liquid crystal is driven on the basis of read data, and a voltage pattern for displaying an image to be displayed is applied to a data electrode.

In the case of driving cholesteric liquid crystal in a condition where a selection voltage is fixed in the DDS method, the viscosity of the cholesteric liquid crystal decreases as the temperature rises. Accordingly, when the temperature of liquid crystal rises, it is necessary to shorten a selection phase in the DDS. However, in the DDS method, all bit-map data corresponding to one line is read in a selection phase. Accordingly, for example, in the case of a high-definition liquid crystal panel having data electrodes of total 4000 lines, there is a possibility that all data will not be read within a selection phase if the selection phase is short because the number of data is large, and as a result, display will not be performed correctly. In this case, a method of raising a frequency of a read clock may be considered. However, there occurs a problem that power consumption increases if the frequency of a read clock is raised. Moreover, in case where a high-voltage circuit that allows driving of cholesteric liquid crystal is assumed, a problem that a driving circuit does not operate if the frequency of a read clock is raised generally occurs.

### SUMMARY

An advantage of some aspects of the invention is to prevent image display from becoming abnormal even at the time of an increase in temperature.

According to an aspect of the invention, there is provided a display driving device for driving a display device having a plurality of display pixels in which a plurality of scanning electrodes and a plurality of data electrodes are provided so as to overlap and correspond to each other and each of which has an electro-optical layer to which driving voltages corresponding to a data voltage and a scanning voltage are applied when the scanning voltage is applied to the scanning electrodes and the data voltage is applied to the data electrodes including: a temperature detecting unit that detects the temperature of the display device; a selection phase setting unit that sets a time interval of a selection phase, in which a driving voltage for selecting gray-scale levels of the display pixels is applied, to a time interval based on a detected temperature when the detected temperature detected by the temperature detecting unit is less than a predetermined temperature and sets a time interval of the selection phase to a fixed time when the detected temperature is equal to or larger than the predetermined temperature; and a voltage applying unit that applies the driving voltage to the display pixels at the time interval set by the selection phase setting unit.

In the display driving device described above, in the case of setting a gray-scale level of each of the display pixels to an intermediate gray-scale level between a first gray-scale level and a second gray-scale level, the voltage applying unit may apply a driving voltage corresponding to the intermediate gray-scale level to the display pixels by controlling an application period of a first driving voltage and an application period of a second driving voltage when one of the first driving voltage, which sets each of the display pixels to the first gray-scale level, and the second driving voltage, which sets each of the display pixels to the second gray-scale level, is applied and then the other voltage is applied in the selection phase.

Furthermore, in the display driving device described above, preferably, the voltage applying unit may apply one of a first driving voltage, which sets each of the display pixels to a first gray-scale level, and a second driving voltage, which sets each of the display pixels to a second gray-scale level, to each of the display pixels by controlling a voltage of the scanning electrodes and a voltage of the data electrodes on the basis of data designating a gray-scale level of the display pixels when the detected temperature is less than a predetermined temperature and may apply one of the first driving voltage, which sets a gray-scale level of each of the display pixels to the first gray-scale level, and a third driving voltage, which is a voltage for setting a gray-scale level of each of the display pixels to the second gray-scale level and is higher than the second driving voltage, to each of the display pixels by controlling a voltage of the scanning electrodes and a voltage of the data electrodes on the basis of data designating a gray-scale level of the display pixels when the detected temperature is equal to or larger than the predetermined temperature.

Furthermore, in the display driving device described above, the voltage applying unit may change the third driving voltage by controlling the voltage of the scanning electrodes and the voltage of the data electrodes on the basis of the detected temperature when the detected temperature is equal to or larger than a predetermined temperature.

Furthermore, in the display driving device described above, the voltage applying unit may apply one of a fourth driving voltage, which is a voltage for setting a gray-scale level of each of the display pixels to a first gray-scale level and is higher than the first voltage, and the third driving voltage, which is a voltage for setting a gray-scale level of each of the display pixels to the second gray-scale level and is higher than the second driving voltage, to each of the display pixels by controlling a voltage of the scanning electrodes and a voltage of the data electrodes on the basis of data designating a gray-scale level of the display pixels when the detected temperature is equal to or larger than a predetermined temperature.

Furthermore, in the display driving device described above, when the detected temperature is equal to or larger than a predetermined temperature, the voltage applying unit may change the third driving voltage by controlling a voltage of the scanning electrodes and a voltage of the data electrodes according to the detected temperature and change the fourth driving voltage by controlling the voltage of the scanning electrodes and the voltage of the data electrodes according to the detected temperature.

Furthermore, in the display driving device described above, in the case of setting a gray-scale level of each of the display pixels to an intermediate gray-scale level between the first gray-scale level and the second gray-scale level, the voltage applying unit may apply a driving voltage between the third driving voltage and the fourth driving voltage corresponding to the gray-scale level by controlling a voltage of the scanning electrodes and a voltage of the data electrodes on the basis of data designating a gray-scale level of the display pixels when the detected temperature is equal to or larger than a predetermined temperature.

According to another aspect of the invention, there is provided a display device including: a plurality of display pixels in which a plurality of scanning electrodes and a plurality of data electrodes are provided so as to overlap and correspond to each other and each of which has an electro-optical layer to which driving voltages corresponding to a data voltage and a scanning voltage are applied when the scanning voltage is applied to the scanning electrodes and the data voltage is applied to the data electrodes; a temperature detecting unit that detects the temperature of the display pixels; a selection phase setting unit that sets a time interval of a selection phase, in which a driving voltage for selecting gray-scale levels of the display pixels is applied, to a time interval based on a detected temperature when the detected temperature detected by the temperature detecting unit is less than a predetermined temperature and sets a time interval of the selection phase to a fixed time when the detected temperature is equal to or larger than the predetermined temperature; and a voltage applying unit that applies the driving voltage to the display pixels at the time interval set by the selection phase setting unit. In addition, according to still another aspect of the invention, there is provided an electronic apparatus including the display device described above.

### BRIEF DESCRIPTION OF THE DRAWINGS

The invention will be described with reference to the accompanying drawings, wherein like numbers reference like elements.

FIG. 1 is a view illustrating the hardware configuration of an electronic apparatus according to an embodiment of the invention.

FIG. 2A, FIG. 2B, and FIG. 2C are views illustrating a cross section of a display device and an alignment state of cholesteric liquid crystal.

FIG. 3 is a view schematically illustrating scanning lines and data lines of the display device.

FIG. 4 is a view illustrating a voltage application period in a DDS.

FIG. 5 is a view illustrating the alignment transition of cholesteric liquid crystal in a DDS.

FIG. 6 is a view illustrating a driving voltage in a DDS.

FIG. 7 is a view illustrating the configuration of a temperature sensor.

FIG. 8 is a view illustrating an example of a table.

FIG. 9 is a view illustrating a circuit that switches a white selection voltage.

FIG. 10 is a view illustrating a circuit that generates a voltage applied to a scanning line.

FIG. 11 is a view schematically illustrating the relationship between a selection voltage and a reflectance caused by a temperature difference.

FIG. 12 is a view illustrating a circuit that switches a white selection voltage and a circuit that switches a black selection voltage.

FIG. 13 is a view illustrating a modification of a circuit that switches a white selection voltage.

FIG. 14 is a view schematically illustrating the relationship between a selection voltage and a reflectance caused by a temperature difference.

### DESCRIPTION OF EXEMPLARY EMBODIMENTS

### First Embodiment

### Configuration of Embodiment

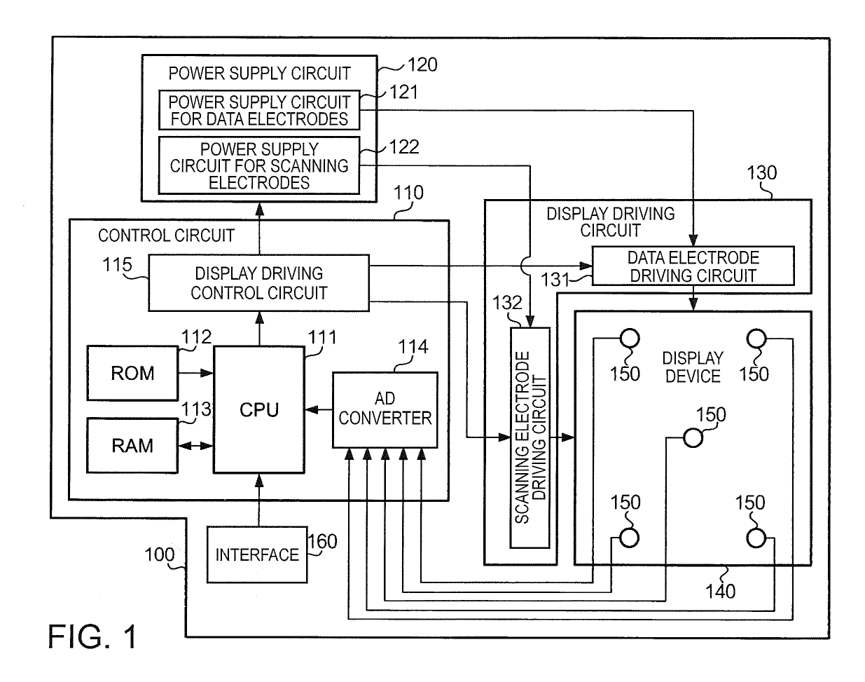

FIG. 1 is a view schematically illustrating the hardware configuration of an electronic apparatus 100 according to an embodiment of the invention. The electronic apparatus 100 is an electronic apparatus for displaying a character, a figure, and an image, such as a photograph, and includes a control circuit 110, a power supply circuit 120, a display driving circuit 130, a display device 140, a plurality of temperature sensors 150, and an interface 160. Hereinafter, the configuration of each component will be described.

### Display Device 140

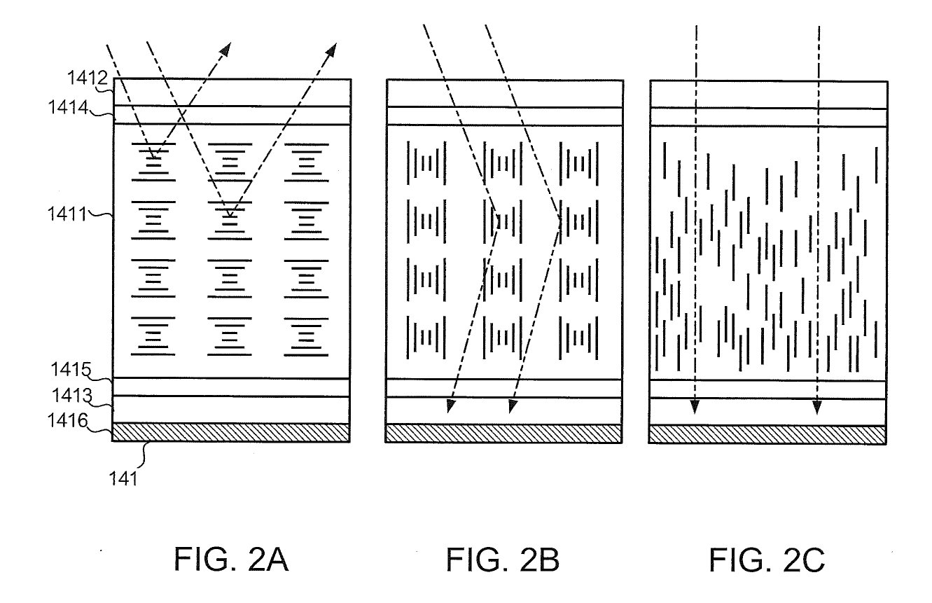

The display device 140 is a device that displays an image. The display device 140 is a device in which an electro-optical layer is interposed between two glass substrates, which are located at upper and lower sides of the electro-optical layer and are provided with transparent electrodes, so that the electro-optical layer is sealed. As the electro-optical layer, the display device 140 has a liquid crystal layer including cholesteric liquid crystal capable of maintaining an alignment state even if power is not supplied. FIG. 2A, FIG. 2B, and FIG. 2C are views illustrating a cross section of the display device 140 and an alignment state of cholesteric liquid crystal. As shown in FIG. 2A, FIG. 2B, and FIG. 2C, the display device 140 includes an upper glass substrate 1412 having an upper transparent electrode 1414, a lower glass substrate 1413 having a lower transparent electrode 1415, a cholesteric liquid crystal layer 1411, and a light absorption layer 1416. In the display device 140, the cholesteric liquid crystal layer 1411 is interposed between the upper glass substrate 1412 and the lower glass substrate 1413 so as to be sealed. In addition, the light absorption layer 1416 is disposed below the lower glass substrate 1413.

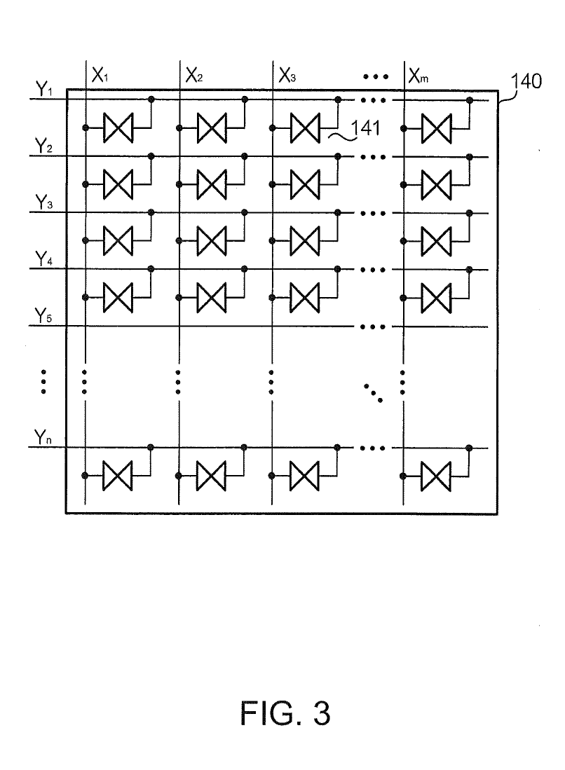

In addition, scanning lines and data lines for applying a voltage to cholesteric liquid crystal are provided in the upper transparent electrode 1414 and the lower transparent electrode 1415. FIG. 3 is a view schematically illustrating such scanning lines and data lines. “n” rows of scanning lines Y₁, Y₂, . . . , Yₙ are provided on one glass substrate of the display device 140, and “m” columns of data lines X₁, X₂, . . . , Xₘ are provided in the direction crossing the scanning lines on the other glass substrate. Thus, a matrix of n×m is formed in the display device 140 (“n” and “m” are positive integers).

A voltage (hereinafter, referred to as a “driving voltage”) equivalent to a difference between a voltage (scanning voltage) applied to scanning lines and a voltage (data voltage) applied to data lines is applied to cholesteric liquid crystal, which is interposed between the scanning lines and the data lines, present at the position where the scanning lines and the data lines overlap each other in plan view. The alignment state of the cholesteric liquid crystal interposed between the scanning lines and data lines changes with a driving voltage. That is, each cholesteric liquid crystal present at the position where the scanning lines and the data lines overlap each other serves as a pixel that forms an image. In the following description, each cholesteric liquid crystal whose alignment state is made to transition individually at the position where scanning lines and data lines overlap each other is referred to as an “electro-optical element 141”.

FIG. 2A is a view schematically illustrating planer alignment (hereinafter, referred to as “P alignment”), FIG. 2B is a view schematically illustrating focal conic alignment (hereinafter, referred to as “F alignment”), and FIG. 2C is a view schematically illustrating homeotropic alignment (hereinafter, referred to as “H alignment”). In the P alignment state, light incident from a side of the upper glass substrate 1412 is reflected from the cholesteric liquid crystal layer 1411 that is in the P alignment state, such that white display is performed. In addition, in the F alignment state, light incident from a side of the upper glass substrate 1412 is transmitted through the cholesteric liquid crystal layer 1411 that is in the F alignment state. Since the light having transmitted through the cholesteric liquid crystal layer 1411 reaches the light absorption layer 1416 to be then absorbed, black display is performed. Moreover, a color having an intermediate gray scale level may be displayed by controlling a voltage applied to cholesteric liquid crystal such that the P alignment state and the F alignment state can exist together. Furthermore, in the H alignment state, a spiral structure as a molecular structure of cholesteric liquid crystal is broken, such that light incident from a side of the upper glass substrate 1412 is transmitted through the cholesteric liquid crystal. In addition, since the H alignment is not a stable state, the H alignment exists only in a state in which a voltage is applied to cholesteric liquid crystal.

Thus, in the display device 140, white and black display can be performed by controlling the alignment state of cholesteric liquid crystal. However, in the present embodiment, the alignment state of cholesteric liquid crystal is changed by using a DDS (dynamic drive scheme).

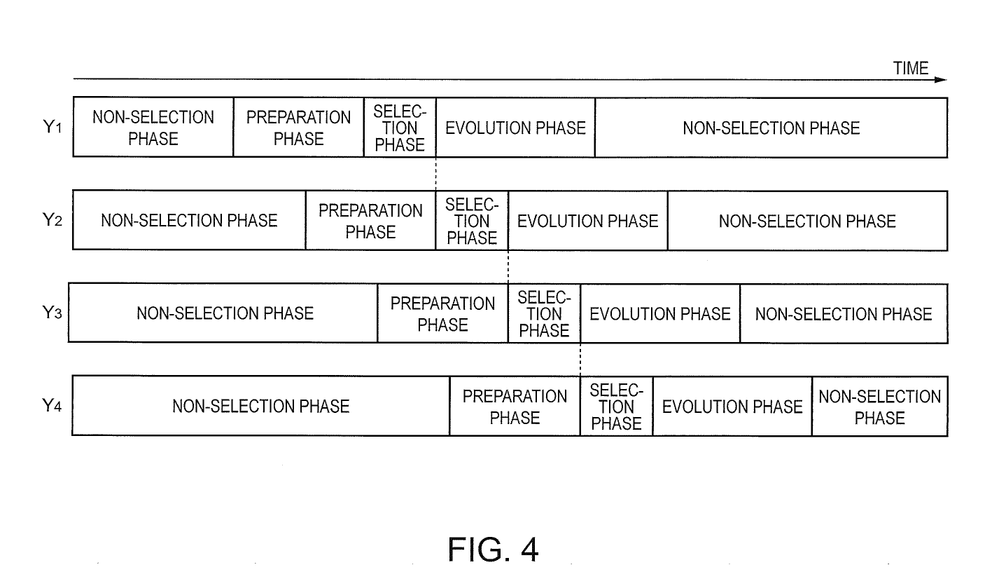

FIG. 4 is a view illustrating a voltage application period when controlling an alignment state of cholesteric liquid crystal by using the DDS. When changing an alignment state of cholesteric liquid crystal by using the DDS, a voltage application period is divided into four phases of anon-selection phase, a preparation phase, a selection phase, and an evolution phase, as shown in FIG. 4. In addition, a selection phase is assigned to the scanning lines Y₁ to Yₙ sequentially for every line (only the scanning lines Y₁ to Y₄ are shown in FIG. 4).

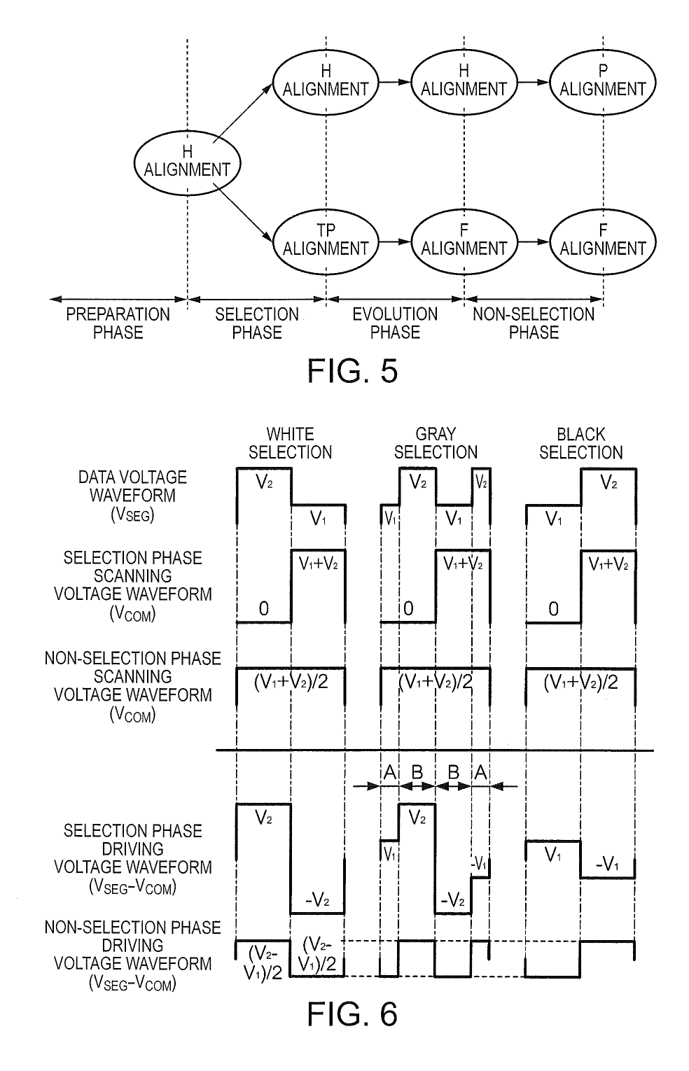

FIG. 5 is a view illustrating the transition of an alignment state of cholesteric liquid crystal in the DDS. First, in a preparation phase, a voltage (hereinafter, referred to as a reset voltage) for causing the electro-optical element 141, which is in a P alignment state or an F alignment state, to change to an H alignment state is applied to the electro-optical element 141. Accordingly, the electro-optical element 141 changes to the H alignment state.

Then, in a selection phase, a selection voltage for changing a display state of the cholesteric liquid crystal to an alignment state corresponding to a requested display state (white or black in the case of two gray-scale levels) is applied. Specifically, a voltage for maintaining an alignment state of H alignment is applied to the electro-optical element 141 in the case of white display, and a voltage for changing the alignment state to a transient planer alignment (hereinafter, referred to as a “TP alignment”), which is an intermediate state of the H alignment and the P alignment, is applied to the electro-optical element 141. As a result, the electro-optical element 141 transitions to either the H alignment state or the TP alignment state corresponding to the requested display state.

Then, in an evolution phase, a voltage (hereinafter, referred to as a “holding voltage”) for maintaining the requested display state is applied. When the holding voltage is applied, the electro-optical element 141 that was in the H alignment state in the selection phase holds the H alignment state and the electro-optical element 141 that has been in the TP alignment state transitions to the F alignment state.

Then, when the holding voltage is removed in a non-selection phase, the electro-optical element 141 that was in the H alignment state in the evolution phase transitions to the P alignment state to thereby perform white display, and the electro-optical element 141 that was in the F alignment state maintains the F alignment to thereby perform black display. In addition, since cholesteric liquid crystal is a material having bistability, it is possible to maintain the P alignment or the F alignment even if a voltage is not applied.

Next, a waveform of a voltage applied to the electro-optical element 141 when changing an alignment state will be described. FIG. 6 is a view illustrating a waveform of a voltage applied to scanning lines in the DDS, a waveform of a voltage applied to data lines, and a waveform of a driving voltage. As shown in FIG. 6, in the present embodiment, positive and negative voltages are alternately applied as a driving voltage to the electro-optical element 141 in order to prevent the cholesteric liquid crystal from deteriorating. In addition, a voltage V₁ shown in FIG. 6 is a black selection voltage V₁ applied as a driving voltage when displaying black, and a voltage V₂ is a white selection voltage V₂ applied as a driving voltage when displaying white.

First, in the case when a pixel is displayed in a white color, a voltage (hereinafter, referred to as a “data voltage V_{SEG}”) of a data line corresponding to the pixel serves as the white selection voltage V₂ for displaying white in a first half of the selection phase and the black selection voltage V₁ for displaying black in a second half of the selection phase. Here, the size relation between V₁ and V₂ is V₂>V₁. At this time, a voltage (hereinafter, referred to as a “scanning voltage V_{COM}”) of a scanning line corresponding to the pixel is set to zero in the first half of the selection phase and to (V₁+V₂) in the second half of the selection phase. Then, a driving voltage (data voltage V_{SEG}−scanning voltage V_{COM}) applied to the electro-optical element 141 corresponding to a pixel in the selection phase is set to V₂ in a first half of the selection phase and to −V₂ in a second half of the selection phase, such that the H alignment state is maintained in the selection phase.

On the other hand, the scanning voltage V_{COM} of a pixel is set to (V₁+V₂)/2 in the non-selection phase. Furthermore, in the non-selection phase, even if either a waveform for white display or a waveform for black display is applied to a data line, an effective value of a driving voltage (data voltage V_{SEG}−scanning voltage V_{COM}) applied to the electro-optical element 141 that is in the H alignment state during the entire non-selection phase is set to (V₂−V₁)/2. Accordingly, the electro-optical element 141 transitions from the H alignment state to the P alignment state to thereby display white.

Moreover, in the case when a pixel is displayed in a black color, a voltage of a data line corresponding to the pixel serves as the black selection voltage V₁ for displaying black in a first half of the selection phase and the white selection voltage V₂ for displaying white in a second half of the selection phase. At this time, a voltage of a scanning line corresponding to a pixel is set to zero in the first half of the selection phase and to (V₁+V₂) in the second half. Then, a driving voltage (data voltage V_{SEG}−scanning voltage V_{COM}) applied to the electro-optical element 141 corresponding to a pixel in the selection phase is set to V₁ in the first half of the selection phase and to −V₁ in the second half of the selection phase, such that the electro-optical element 141 is in the TP alignment state in the selection phase. Then, the electro-optical element 141 that was in the TP alignment state transitions to the F alignment in the evolution phase, thereby displaying black.

In addition, in the case when a pixel is set to an intermediate gray-scale level, the black selection voltage V₁ and the white selection voltage V₂ are applied to a data line corresponding to the pixel in the first half of the selection phase and the black selection voltage V₁ and the white selection voltage V₂ are also applied to the data line corresponding to the pixel in the second half of the selection phase. Then, the driving voltage (data voltage V_{SEG}−scanning voltage V_{COM}) applied to the electro-optical element 141 corresponding to the pixel in the selection phase is set to V₂ after V₁ in the first half of the selection phase and to −V₁ after −V₂ in the second half of the selection phase, such that the P alignment state and the F alignment state exist together to thereby display an intermediate gray-scale level. In addition, in the first half and the second half of the selection phase, a period for which the white selection voltage V₂ is applied is different from a period for which the black selection voltage V₁ is applied as shown in FIG. 6. Accordingly, it may also be possible to change a gray-scale level by controlling the pulse width of the white selection voltage V₂.

### Temperature Sensor 150

The temperature sensor 150 serves as a sensor for measuring the temperature and is disposed below the light absorption layer 1416. In the present embodiment, the five temperature sensors 150 are disposed on a bottom surface of the rectangular light absorption layer 1416. One of the five temperature sensors 150 is disposed in the middle of the light absorption layer 1416 and the other four temperature sensors 150 are disposed at four rectangular corners, as shown in FIG. 1.

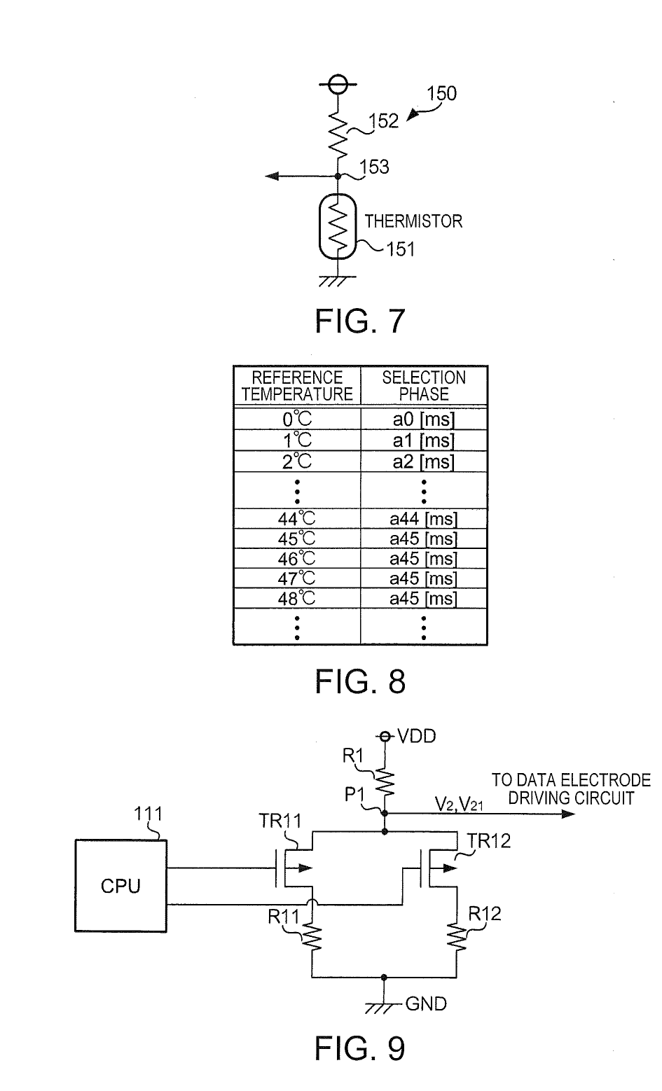

In addition, the temperature sensor 150 has a thermistor 151 and a resistor 152, as shown in FIG. 7. One end of the thermistor 151 is grounded and the other end is connected to one end of the resistor 152. In addition, the other end of the resistor 152 is connected to a voltage source. The thermistor 151 is an element whose resistance changes with the temperature. Accordingly, when a resistance of the thermistor 151 changes according to a temperature change in the temperature sensor 150 shown in FIG. 7, a voltage value of a connection point 153 between the thermistor 151 and the resistor 152 changes according to the change. That is, since the voltage value of the connection point 153 changes according to the temperature change in the thermistor 151, the temperature of a portion where the temperature sensor 150 is provided can be detected by sensing the voltage value of the connection point 153.

### Interface 160

The interface 160 has a key used to operate the electronic apparatus 100, such as a rewriting key for rewriting a display displayed on the display device 140. When a key is operated, the interface 160 outputs to the control circuit 110 a signal indicating that the key has been operated.

In addition, the interface 160 has a communication interface function for communication with other computer apparatuses. The interface 160 receives various kinds of data (for example, image data for expressing an image) transmitted from other computer apparatuses and outputs the received data to a CPU 111.

### Control Circuit 110

The control circuit 110 serves as a circuit that controls the display driving circuit 130 and has the CPU (central processing unit) 111, a ROM (read only memory) 112, a RAM (random access memory) 113, an AD (analog digital) converter 114, and a display driving control circuit 115. The ROM 112, RAM 113, the display driving control circuit 115, and the power supply circuit 120 are connected to the CPU 111. The CPU 111 operates according to a control program stored in the ROM 112 and controls the display driving control circuit 115. In addition, the AD converter 114 and the interface 160 are connected to the CPU 111. The CPU 111 controls the display driving control circuit 115 on the basis of a signal input from the interface 160 or a signal input from the AD converter 114. In addition, image data received from other computer apparatuses through the interface 160 is stored in the RAM 113.

In addition, a table TB1 shown in FIG. 8 is stored in the ROM 112. The Table TB1 has a “reference temperature” field and a “selection phase” field. A numerical value indicating the temperature is stored in the “reference temperature” field and a time indicating a time interval of the selection phase shown in FIG. 4 is stored in the “selection phase” field. Furthermore, in the table TB1, as the temperature increases from a low temperature, a time stored corresponding to the temperature becomes short like a0 [ms]>a1 [ms]>a2 [ms]> . . . >a44 [ms]>a45 [ms]. Furthermore, in the present embodiment, every time stored corresponding to a temperature of 45° C. or more is set to the same time (a45 [ms]).

The AD converter 114 is a circuit that converts an analog signal into a digital signal and is connected at each connection point 153 of the plurality of temperature sensors 150 disposed in the display device 140. The AD converter 114 converts a voltage value at the connection point 153 into a digital value and outputs the digital value to the CPU 111.

The display driving control circuit 115 serves as a circuit that controls the power supply circuit 120 or the display driving circuit 130 under the control of the CPU 111. The display driving control circuit 115 has a VRAM (video random access memory; not shown) and stores bit-map data for expressing an image in the VRAM.

### Power Supply Circuit 120

The power supply circuit 120 has a power supply circuit 121 for data electrodes, which is connected to a data electrode driving circuit 131, and a power supply circuit 122 for scanning electrodes, which is connected to a scanning electrode driving circuit 132. The power supply circuit 121 for data electrodes is a circuit that generates the black selection voltage V₁ shown in FIG. 6 and the white selection voltage V₂ shown in FIG. 6 and supplies the generated voltages to the data electrode driving circuit 131.

In addition, the power supply circuit 122 for scanning electrodes is a circuit that generates a reset voltage, a holding voltage, voltages (0 V, V₁+V₂, (V₁+V₂)/2 shown in FIG. 6) applied to scanning lines in a selection phase or a non-selection phase, and the like and supplies the generated voltages to the scanning electrode driving circuit 132.

### Data Electrode Driving Circuit 131 and Scanning Electrode Driving Circuit 132

The scanning electrode driving circuit 132 serves as a circuit that applies a voltage to a scanning line. The scanning electrode driving circuit 132 selects the voltages supplied from the power supply circuit 122 for scanning electrodes, such as the reset voltage, the holding voltage, and the voltages applied to the scanning lines in the selection phase or the non-selection phase, under the control of the display driving control circuit 115 and outputs the selected voltage, such that a voltage having a waveform shown in FIG. 6 is applied to the scanning line.

In addition, the data electrode driving circuit 131 serves as a circuit that applies a voltage to a data line. The data electrode driving circuit 131 selects any one of the voltages supplied from the power supply circuit 121 for data electrodes according to data transmitted from the display driving control circuit 115 and outputs the select voltage, such that the voltage having a waveform shown in FIG. 6 is applied to each data line.

### Operation of Embodiment

Next, an operation when performing image display in the electronic apparatus 100 according to the present embodiment will be described.

### Image Display Operation

First, when a user performs an operation of instructing display of an image, which is expressed by image data stored in the RAM 113, through the interface 160, the CPU 111 acquires a digital value output from the AD converter 114, that is, a value indicating the temperature measured by the temperature sensor 150 and stores the acquired value in the RAM 113. In the present embodiment, since five temperature sensors are disposed in the display device 140, five digital values corresponding to the temperature sensors 150 are stored in the RAM 113. When the digital values are stored in the RAM 113, the CPU 111 converts the stored digital values into temperature values. In addition, when the digital values are converted into the temperature values, a table indicating the correspondence relationship between a digital value and a temperature value may be used or a digital value may be converted into a temperature value on the basis of an expression stored beforehand. Then, the CPU 111 calculates an average (central value) of the five converted temperature values. When the average of the temperature values is calculated, the CPU 111 reads the time interval stored in the table TB1 so as to match the same value as the calculated average. For example, in the case where the average is in a range equal to or larger than 44° C. and smaller than 45° C., “a44 [ms]” is read as a time of a selection phase from the table TB1 shown in FIG. 8. Then, the CPU 111 outputs the read time to the display driving control circuit 115.

When the CPU 111 completes outputting the time to the display driving control circuit 115, the CPU 111 generates bit-map data of an image corresponding to n rows by m columns, which is expressed by image data stored in the RAM 113. Then, the generated bit-map data is output to the display driving control circuit 115. When the display driving control circuit 115 receives the bit-map data from the CPU 111, the display driving control circuit 115 stores the bit-map data in the VRAM. Then, when storage of bit-map data is completed in the display driving control circuit 115, display of an image expressed by the bit-map data is performed in the display device 140.

Hereinafter, display of an image will be specifically described paying attention to the scanning line Y₁ of the display device 140. First, a reset voltage is output from the scanning electrode driving circuit 132 to be applied to the scanning line Y₁ in the preparation phase shown in FIG. 4, and the preparation phase changes to the selection phase when the preparation phase ends. Here, the time interval of the selection phase is set to “a44 [ms]” that is a time output from the CPU 111 to the display driving control circuit 115. In the selection phase, first row data of an image expressed by bit-map data is output from the display driving control circuit 115 to the data electrode driving circuit 131 so as to be read into the data electrode driving circuit 131. In addition, a voltage having a selection phase scanning voltage waveform shown in FIG. 6 is applied from the scanning electrode driving circuit 132 to the scanning line Y₁.

On the other hand, in the data lines X₁, X₂, . . . , and Xₘ, a voltage is applied from the data electrode driving circuit 131 according to the bit-map data output from the display driving control circuit 115. For example, in the case when a first column pixel of first row bit-map data is white, a voltage having a waveform corresponding to the white selection voltage V₂ in the first half of the selection phase and the black selection voltage V₁ in the second half of the selection phase, which is shown in FIG. 6, is applied to the data line X₁. Accordingly, to the electro-optical element 141 present at the position where the scanning line Y₁ and the data line X₁ cross each other, the voltage V₂ is applied in the first half of the selection phase and the voltage −V₂ is applied in the second half of the selection phase. As a result, the cholesteric liquid crystal changes to the H alignment state.

In addition, for example, in the case when a second column pixel of bit-map data is black, a voltage having a waveform corresponding to the black selection voltage V₁ in the first half of the selection phase and to the white selection voltage V₂ in the second half of the selection phase, which is shown in FIG. 6, is applied to the data line X₂. Accordingly, to the electro-optical element 141 present at the position where the scanning line Y₁ and the data line X₂ cross each other, the voltage V₁ is applied in the first half of the selection phase and the voltage −V₁ is applied in the second half of the selection phase. As a result, the cholesteric liquid crystal changes to the TP alignment state.

Then, when the selection phase is completed, a change to the evolution phase is made. In the evolution phase, a holding voltage is applied to the cholesteric liquid crystal. Accordingly, in the electro-optical element 141 present at the position where the scanning line Y₁ and the data line X₁ cross each other, the alignment state of the cholesteric liquid crystal becomes in the H alignment state, and accordingly, the H alignment state is maintained. In the electro-optical element 141 present at the position where the scanning line Y₁ and the data line X₂ cross each other, the alignment state of the cholesteric liquid crystal becomes in the TP alignment state, and accordingly, a change to the F alignment state is made.

Thereafter, when a change from the evolution phase to the non-selection phase is made, a voltage having a non-selection phase scanning voltage waveform shown in FIG. 6 is applied from the scanning electrode driving circuit 132 to the scanning line Y₁, such that the holding voltage is removed. Then, the electro-optical element 141 present at the position where the scanning line Y₁ and the data line X₁ cross each other, which was in the H alignment state in the evolution phase, changes to the P alignment to thereby display white, and the electro-optical element 141 present at the position where the scanning line Y₁ and the data line X₂ cross each other, which was in the F alignment state in the evolution phase, maintains the F alignment state to thereby display black.

### Operation at the Time of Increase in Temperature

For example, the temperature of the display device 140 is increased when sunlight or light of an incandescent lamp strikes upon a surface of the display device 140. When the temperature of the display device 140 rises and an operation instructing the display of an image is performed again by a user after the operation described above, the CPU 111 calculates the average of temperature values of positions of the temperature sensors 150 from an output result of the plurality of temperature sensors 150 in the same manner as the operation mentioned above. Here, in the case where the average of the temperature values rises to reach, for example, a temperature within a range equal to or larger than 45° C. and smaller than 46° C., the time interval “a45 [ms]”, which is shorter than that in the case when the average of temperature values is 44° C., is read as a time of the selection phase from the table TB1 shown in FIG. 8. Then, the CPU 111 outputs the read time interval to the display driving control circuit 115.

Then, similar to the operation described above, bit-map data is output to the display driving control circuit 115 and various kinds of voltages are applied to scanning lines and data lines. In addition, when applying various kinds of voltages, the time interval in the selection phase is set to “a45 [ms]” that the display driving control circuit 115 has received from the CPU 111. Thus, in the electronic apparatus 100, the time interval of the selection phase becomes short at the time of an increase in temperature. As a result, since the time interval is set to a time interval corresponding to the temperature of the display device 140, abnormal display does not occur.

In addition, when sunlight or light of an incandescent lamp keeps striking, the temperature of the display device 140 further rises. When the temperature of the display device 140 further rises and an operation instructing the display of an image is performed again by a user, the CPU 111 calculates the average of temperature values of positions of the temperature sensors 150 from an output result of the plurality of temperature sensors 150 in the same manner as the operation mentioned above. Here, in the case where the average of the temperature values rises to reach, for example, a temperature within a range equal to or larger than 47° C. and smaller than 48° C., the time interval “a45 [ms]”, which is equal to that in the case when the average of temperature values is 45° C., is read as a time interval of the selection phase from the table TB1 shown in FIG. 8. Then, the CPU 111 outputs the read time to the display driving control circuit 115. That is, when the average of temperature values becomes 45° C. or more, the time interval of the selection phase becomes fixed regardless of an average temperature value.

Then, similar to the operation described above, bit-map data is output to the display driving control circuit 115 and various kinds of voltages are applied to scanning lines and data lines. Here, when applying various kinds of voltages, the time interval in the selection phase is set to “a45 [ms]” that the display driving control circuit 115 has received from the CPU 111. Thus, when a temperature value of the display device 140 becomes a predetermined value or more, the time interval of the selection phase is fixed to a predetermined time interval. This time interval is set to be longer than a time required to output bit-map data corresponding to one row from the display driving control circuit 115 to the data electrode driving circuit 131. Accordingly, even if the time interval of a selection phase is decreased according to an increase in temperature in a high-definition display device having thousands of data lines, all bit-map data corresponding to one row can be read into the data electrode driving circuit 131 in the selection phase. As a result, correct display is performed.

Moreover, in the case when the actual temperature of liquid crystal is 47° C. on the basis of the time interval “a45 [ms]” in the selection phase, a voltage corresponding to a gray level is changed such that the gray value can be displayed at 47° C. by controlling the width of A and B phases in FIG. 6. Thus, it is possible to display a gray-scale level even at 47° C.

### Second Embodiment

### Configuration of Embodiment

Next, a second embodiment of the invention will be described. An electronic apparatus 100 according to the present embodiment has almost the same configuration as the electronic apparatus 100 according to the first embodiment except that the configurations of a power supply circuit 121 for data electrodes and a power supply circuit 122 for scanning electrodes are different from those in the first embodiment. Moreover, in the present embodiment, an operation when the temperature detected by a temperature sensor 150 reaches a predetermined temperature or more is different from that in the first embodiment. Hereinafter, a point different from the first embodiment will be described.

### Configuration of Power Supply Circuit 121 for Data Electrodes

FIG. 9 is a view illustrating a circuit provided in the power supply circuit 121 for data electrodes.

This circuit serves as a circuit that outputs a white selection voltage applied to a data line and includes resistors R1, R11, and R12 and P-channel field effect transistors TR11 and TR12 (hereinafter, simply referred to as a “transistor TR11” and a “transistor TR12”). One end of the resistor R1 is connected to a power supply VDD, and the other end is connected to a source of the transistor TR11 and a source of the transistor TR12.

In addition, a connection line that connects the transistors TR11 and TR12 with the resistor R1 is connected to a data electrode driving circuit 131 (hereinafter, a point of the connection line connected to the data electrode driving circuit 131 is referred to as a connection point P1).

Gates of the transistors TR11 and TR12 are connected to a CPU 111. In addition, a drain of the transistor TR11 is connected to the resistor R11, and a drain of the transistor TR12 is connected to the resistor R12. In addition, ends of the resistors R11 and R12 not connected to the transistors are connected to a ground GND. In addition, a resistance of the resistor R11 is different from that of the resistor R12.

When the CPU 111 applies a voltage to the gate of the transistor TR12 without applying a voltage to the gate of the transistor TR11, the transistor TR11 is turned on and the transistor TR12 is turned off. Accordingly, since a current flows from the power supply VDD to the resistor R11 through the transistor TR11, a voltage at the connection point P1 is set to the white selection voltage V₂ by voltage division between the resistor R1 and the resistor R11. On the other hand, when the CPU 111 applies a voltage to the gate of the transistor TR11 without applying a voltage to the gate of the transistor TR12, the transistor TR12 is turned on and the transistor TR11 is turned off. Accordingly, since a current flows from the power supply VDD to the resistor R12 through the transistor TR12, the voltage at the connection point P1 is set to a white selection voltage V₂₁, which is higher than the white selection voltage V₂, by voltage division between the resistor R1 and the resistor R12.

### Configuration of Power Supply Circuit 122 for Scanning Electrodes

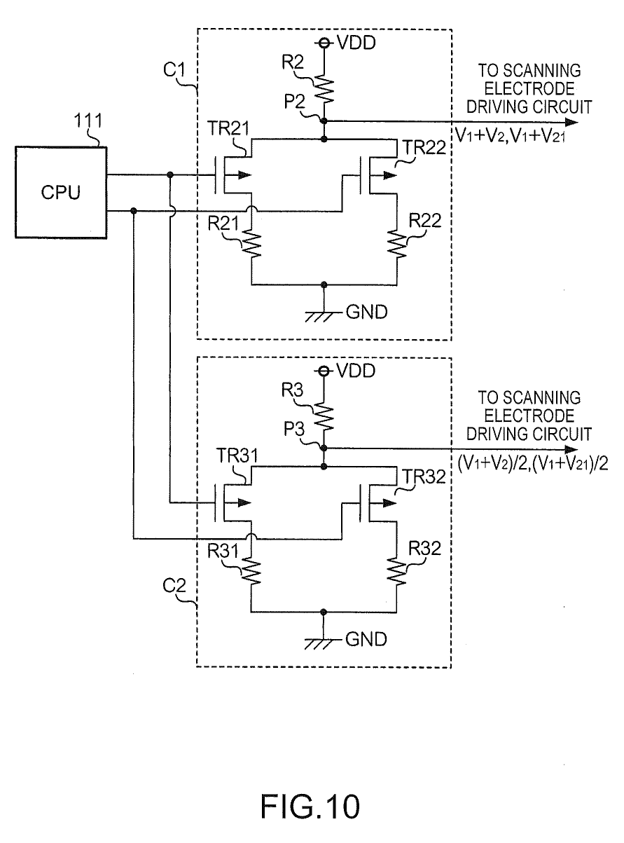

Next, FIG. 10 is a view illustrating a circuit provided in the power supply circuit 122 for scanning electrodes. This circuit serves as a circuit that generates a voltage applied to scanning lines in a selection phase and a voltage applied to scanning lines in a non-selection phase. Specifically, a circuit C1 shown in FIG. 10 is a circuit that generates a voltage applied to scanning lines in the selection phase, and a circuit C2 shown in FIG. 10 is a circuit that generates a voltage applied to scanning lines in the non-selection phase.

First, the circuit C1 is a circuit that outputs a voltage applied to scanning lines in the selection phase and includes resistors R2, R21, and R22 and P-channel field effect transistors TR21 and TR22 (hereinafter, simply referred to as a “transistor TR21” and a “transistor TR22”). Each of the resistors and transistors has the same configuration as the circuit shown in FIG. 9.

In the circuit C1, when the CPU 111 applies a voltage to a gate of the transistor TR22 without applying a voltage to a gate of the transistor TR21, a current flows from the power supply VDD to the resistor R21 through the transistor TR21. As a result, a voltage at a connection point P2 is set to (V₁+V₂) by voltage division between the resistor R2 and the resistor R21.

On the other hand, when the CPU 111 applies a voltage to the gate of the transistor TR21 without applying a voltage to the gate of the transistor TR22, the transistor TR22 is turned on and the transistor TR21 is turned off. Accordingly, since a current flows from the power supply VDD to the resistor R22 through the transistor TR22, the voltage at the connection point P2 is set to (V₁+V₂₁), which is higher than (V₁+V₂), by voltage division between the resistor R2 and the resistor R22.

In addition, the circuit C2 is a circuit that outputs a voltage applied to scanning lines in the non-selection phase and includes resistors R3, R31, and R32 and P-channel field effect transistors TR31 and TR32 (hereinafter, simply referred to as a “transistor TR31” and a “transistor TR32”). Each of the resistors and transistors has the same configuration as the circuit shown in FIG. 9.

In the circuit C2, when the CPU 111 applies a voltage to a gate of the transistor TR32 without applying a voltage to a gate of the transistor TR31, a current flows from the power supply VDD to the resistor R31 through the transistor TR31. As a result, a voltage at a connection point P3 is set to (V₁+V₂)/2 by voltage division between the resistor R3 and the resistor R31. On the other hand, when the CPU 111 applies a voltage to the gate of the transistor TR31 without applying a voltage to the gate of the transistor TR32, the transistor TR32 is turned on and the transistor TR31 is turned off. Accordingly, since a current flows from the power supply VDD to the resistor R32 through the transistor TR32, the voltage at the connection point P3 is set to (V₁+V₂₁)/2, which is higher than (V₁+V₂)/2, by voltage division between the resistor R3 and the resistor R32.

### Operation of Embodiment

Next, an operation when performing image display in the electronic apparatus 100 according to the present embodiment will be described.

### Image Display Operation

First, if a user performs an operation, which instructs the display of an image expressed by image data stored in the RAM 113, through the interface 160 when the average of temperatures detected in the five temperature sensors 150 is 44° C., a time of a selection phase is set to a44 [ms] like the first embodiment described above.

In addition, when the average of temperature is less than 45° C., the CPU 111 applies a voltage to the gates of the transistors TR12, TR22, and TR32 without applying a voltage to the gates of the transistors TR11, TR21, and TR31. Then, in the circuit shown in FIG. 9 that is provided in the power supply circuit 121 for data electrodes, the white selection voltage V₂ is supplied from the connection point P1 to the data electrode driving circuit 131. Furthermore, in the circuit C1 provided in the power supply circuit 122 for scanning electrodes, a voltage (V₁+V₂) is supplied from the connection point P2 to the scanning electrode driving circuit 132. In the circuit C2, a voltage (V₁+V₂)/2 is supplied from the connection point P3 to the scanning electrode driving circuit 132. Furthermore, when driving the display device 140, these voltages are selected to be applied to the display device 140, such that image display is performed.

Then, when the average of temperatures detected by the five temperature sensors 150 reaches 45° C. or more due to striking of sunlight or light of an incandescent lamp upon a surface of the display device 140 and then an operation instructing the display of an image is performed again by a user, a time interval of “a45 [ms]”, which is shorter than that when the average of temperature is 44° C., is read as a time of a selection phase from the table TB1 shown in FIG. 8. Then, the CPU 111 outputs the read time interval to the display driving control circuit 115.

In addition, when the average of temperature reaches 45° C. or more, the CPU 111 applies a voltage to the gates of the transistors TR11, TR21, and TR31 without applying a voltage to the gates of the transistors TR12, TR22, and TR32. Then, in the circuit shown in FIG. 9 that is provided in the power supply circuit 121 for data electrodes, the white selection voltage V₂₁, which is higher than the earlier white selection voltage V₂, is supplied from the connection point P1 to the data electrode driving circuit 131. Furthermore, in the circuit C1 provided in the power supply circuit 122 for scanning electrodes, a voltage (V₁+V₂₁) higher than the voltage (V₁+V₂) is supplied from the connection point P2 to the scanning electrode driving circuit 132. In the circuit C3, a voltage (V₁+V₂₁)/2 higher than the voltage (V₁+V₂)/2 is supplied from the connection point P3 to the scanning electrode driving circuit 132.

In addition, when driving the display device 140, these voltages are selected to be applied to the display device 140. Hereinafter, a specific explanation will be focused on the scanning line Y₁ of the display device 140. When a preparation phase is completed to shift to a selection phase, a voltage of the scanning line Y₁ is zero in a first half of the selection phase and a voltage of (V₁+V₂₁) supplied from the power supply circuit 122 for scanning electrodes is supplied from the scanning electrode driving circuit 132 to the scanning line Y₁ in a second half.

On the other hand, in the data lines X₁, X₂, . . . , and Xₘ, a voltage is applied from the data electrode driving circuit 131 according to the bit-map data output from the display driving control circuit 115. For example, in the case when a first column pixel of first row bit-map data is white, a voltage having a waveform corresponding to the white selection voltage V₂₁, which is higher than the white selection voltage V₂, in the first half of the selection phase and the black selection voltage V₁ in the second half of the selection phase, is applied to the data line X₁. Accordingly, to the electro-optical element 141 present at the position where the scanning line Y₁ and the data line X₁ cross each other, the voltage V₂₁ is applied in the first half of the selection phase and the voltage −V₂₁ is applied in the second half of the selection phase. As a result, the cholesteric liquid crystal changes to the H alignment state.

In addition, for example, in the case when a second column pixel of bit-map data is black, a voltage having a waveform corresponding to the black selection voltage V₁ in the first half of the selection phase and the white selection voltage V₂₁, which is higher than the white selection voltage V₂, in the second half of the selection phase is applied to the data line X₂. Accordingly, to the electro-optical element 141 present at the position where the scanning line Y₁ and the data line X₂ cross each other, the voltage V₁ is applied in the first half of the selection phase and the voltage −V₁ is applied in the second half of the selection phase. As a result, the cholesteric liquid crystal changes to the TP alignment state.

Thereafter, when a change to the non-selection phase through the evolution phase is made, a voltage (V₁+V₂₁)/2 higher than the voltage (V₁+V₂)/2 is applied from the scanning electrode driving circuit 132 to the scanning line Y₁, such that the holding voltage is removed. Then, the electro-optical element 141 present at the position where the scanning line Y₁ and the data line X₁ cross each other, which was in the H alignment state in the evolution phase, changes to the P alignment to thereby display white, and the electro-optical element 141 present at the position where the scanning line Y₁ and the data line X₂ cross each other, which was in the F alignment state in the evolution phase, maintains the F alignment state to thereby display black.

In addition, when sunlight or light of an incandescent lamp keeps striking, the temperature of the display device 140 further rises. When the temperature of the display device 140 further rises and then an operation instructing the display of an image is performed again by a user, the CPU 111 calculates the average of temperature values of positions of the temperature sensors 150 from an output result of the plurality of temperature sensors 150 in the same manner as the operation mentioned above. Here, in the case where the average of the temperature values rises to reach, for example, 47° C., the time interval “a45 [ms]”, which is equal to that in the case when the average of temperature values is 45° C., is read as a time interval of the selection phase from the table TB1 shown in FIG. 8. Then, the CPU 111 outputs the read time to the display driving control circuit 115. That is, when the average of temperature values becomes 45° C. or more, the time interval of the selection phase becomes fixed regardless of an average temperature value.

In addition, similar to the case when the average of temperature is 45° C., the CPU 111 applies a voltage to the gates of the transistors TR11, TR21, and TR31 without applying a voltage to the gates of the transistors TR12, TR22, and TR32. As a result, the same voltage as when the average of temperature is 45° C. is output from the power supply circuit 121 for data electrodes and the power supply circuit 122 for scanning electrodes and the output voltage is suitably applied to the display device 140, such that an image is displayed.

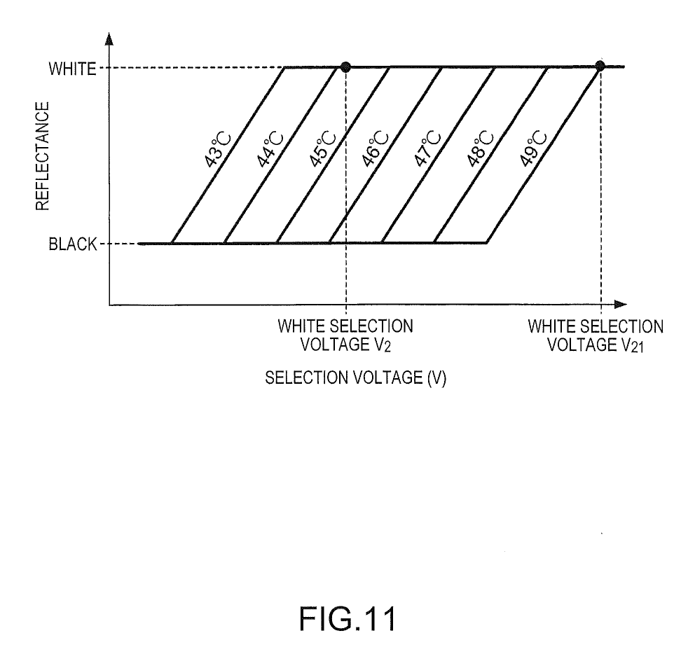

FIG. 11 is a view schematically illustrating the temperature characteristic of the relationship between a selection voltage when a selection phase is fixed and a reflectance of cholesteric liquid crystal. In FIG. 11, a horizontal axis indicates the selection voltage and a vertical axis indicates the reflectance. The reflectance is a relative value when the reflection brightness of a standard white plate as a reference is set to 100%. A high reflectance (white level) means that cholesteric liquid crystal approaches a planer alignment state such that a white color becomes strong, and a low reflectance (black level) means that cholesteric liquid crystal approaches a focal conic alignment state such that a black color becomes strong. A reflectance between a white level and a black level means that an intermediate tone (gray) between white and black is expressed.

From FIG. 11, it can be seen that if a white selection voltage is V₂ when the temperature of cholesteric liquid crystal is 45° C., the reflectance is not 100% and white is not displayed correctly. However, in the present embodiment, when the temperature of cholesteric liquid crystal reaches 45° C. or more the white selection voltage is set to V₂₁ higher than V₂. Accordingly, even if the temperature of cholesteric liquid crystal reaches 45° C. or more, a portion where white is to be displayed is not expressed in gray or black, and display is performed correctly.

### Modifications

Having described the embodiments of the invention, the invention is not limited to the above embodiments but various changes and modifications thereof could be made. For example, the invention may also be performed by modifying the above-mentioned embodiments as follows.

In the embodiments described above, the time interval of a selection phase is fixed when the temperature detected by the temperature sensor 150 reaches 45° C. or more. However, a point of time at which the time interval is fixed is not limited to 45° C. or more. For example, a time stored in the table TB1 may be changed such that the time interval of a selection phase is fixed when the temperature sensor 150 reaches 46° C. or more or the time interval of a selection phase is fixed when the temperature sensor 150 reaches 44° C. or more.

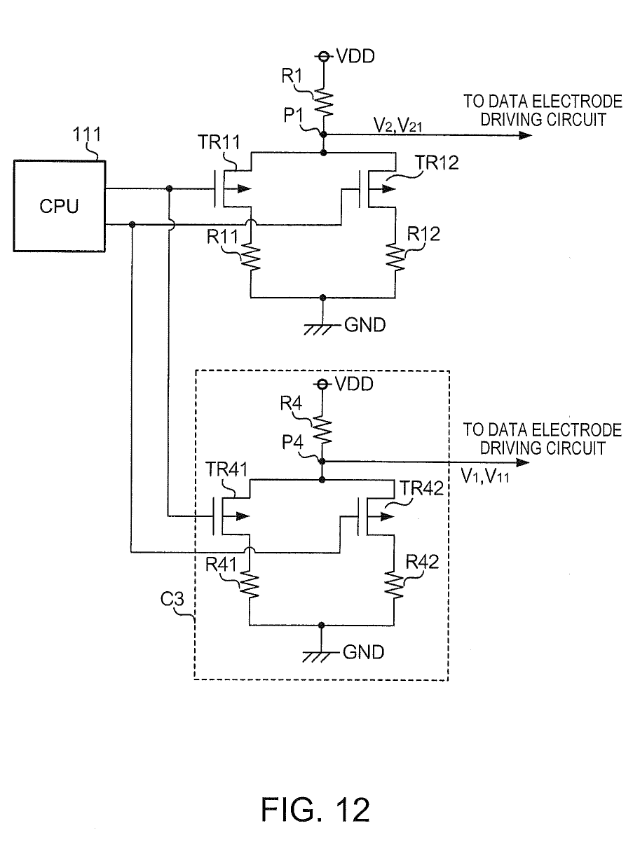

In the embodiments described above, the power supply circuit 121 for data electrodes may include a circuit C3, which has resistors R4, R41, and R42 and P-channel field effect transistors TR41 and TR42 (hereinafter, simply referred to as a “transistor TR41” and a “transistor TR42”), in addition to the circuit shown in FIG. 9 as shown in FIG. 12. The circuit C3 serves as a circuit that outputs a black selection voltage applied to data lines. Each of the resistors and transistors has the same configuration as the circuit shown in FIG. 9.

When the CPU 111 applies a voltage to a gate of the transistor TR42 without applying a voltage to a gate of the transistor TR41, the transistor TR41 is turned on and the transistor TR42 is turned off. Accordingly, since a current flows from the power supply VDD to the resistor R41 through the transistor TR41, a voltage at a connection point P4 is set to the black selection voltage V₁ by voltage division between the resistor R4 and the resistor R41. On the other hand, when the CPU 111 applies a voltage to the gate of the transistor TR41 without applying a voltage to the gate of the transistor TR42, the transistor TR42 is turned on and the transistor TR41 is turned off. Accordingly, since a current flows from the power supply VDD to the resistor R42 through the transistor TR42, the voltage at the connection point P4 is set to a black selection voltage V₁₁, which is higher than the black selection voltage V₁, by voltage division between the resistor R4 and the resistor R42.

In the electronic apparatus 100 having the circuit, when the temperature detected by the temperature sensor 150 reaches a predetermined temperature or more, it may be possible to make the time interval of a selection phase fixed and to switch a white selection voltage from V₂ to V₂₁ and switch a black selection voltage from V₁ to V₁₁ such that the black selection voltage and the white selection voltage are shifted. Thus, by switching the white selection voltage and the black selection voltage such that a non-selection voltage (V₂₁−V₁₁)/2 in a non-selection phase is fixed, it can be prevented that the non-selection voltage becomes too large, and accordingly, display changes in the non-selection phase.

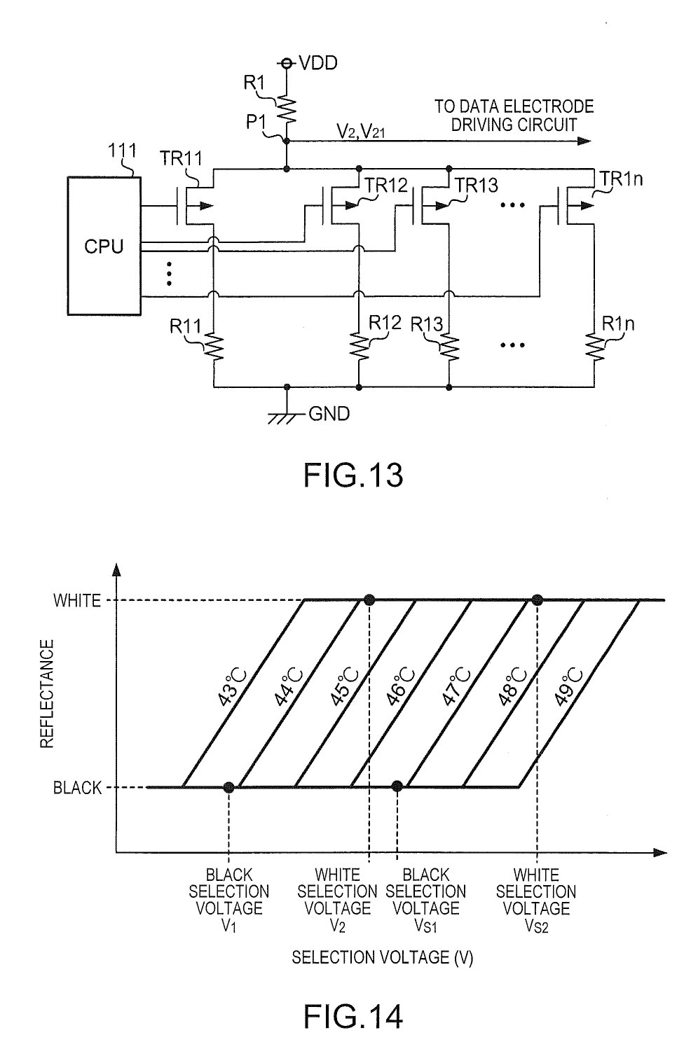

In addition, as shown in FIG. 13, a plurality of sets of transistors and dividing resistors may be provided by changing the circuit shown in FIG. 9. Dividing resistors R11 to R1n may have different resistances. A voltage output from the connection point P1 may also be switched in multiple steps by causing the CPU 111 to control ON and OFF of each transistor. In the circuit shown in FIG. 12, it is preferable to set the resistances of the resistors R11 to R1n such that the voltage output from the connection point P1 is also sequentially increased as transistors that are turned on are switched sequentially from TR11 to TR1n.

In addition, for example, transistors may be turned on according to an increase in temperature such that only the transistor TR12 is turned on when the temperature detected by the temperature sensor 150 is 45° C. and only the transistor TR13 is turned on when the temperature detected by the temperature sensor 150 is 46° C. According to this configuration, a white selection voltage increases sequentially according to an increase in temperature.

Furthermore, even in a case when a circuit that changes a black selection voltage is provided, the circuit that changes a black selection voltage may be configured to have the same circuit configuration as the circuit shown in FIG. 13 such that a black selection voltage is switched in multiple steps. In this case, a black selection voltage may be changed simultaneously with changing a white selection voltage according to the increase in temperature of liquid crystal, and the black selection voltage and the white selection voltage may be shifted according to the increase in temperature.

For example, in the embodiments described above, it is assumed that selection voltages are set to a black selection voltage V₁ and a white selection voltage V₂ shown in FIG. 14 (drawing schematically illustrating the temperature characteristic of the relationship between a selection voltage when a selection phase is fixed and a reflectance of cholesteric liquid crystal) at the time of a temperature less than 45° C.

Here, in the case when the temperature detected by the temperature sensor 150 is 47° C., for example, a black selection voltage is shifted to a black selection voltage V_{S1} and a white selection voltage is shifted to a white selection voltage V_{S2}, as shown in FIG. 14. When the temperature reaches 47° C., intermediate gray-scale display can also be correctly performed by controlling a voltage application period of the black selection voltage V_{S1} and the white selection voltage V_{S2} like the data voltage waveform for gray selection of FIG. 6.

Furthermore, similar to the circuit shown in FIG. 13, the circuit shown in FIG. 10 may also have a configuration in which a plurality of sets of transistors and dividing resistors are provided, such that a voltage applied in a selection phase or a voltage applied in a non-selection phase is switched in multiple steps together with switching of a white selection voltage.

In the embodiments described above, although the plurality of temperature sensors 150 are provided, one temperature sensor 150 may also be provided. Furthermore, in the embodiments described above, the time interval of a selection phase or a white selection voltage is switched by using the average of temperatures detected by the plurality of temperature sensors 150. However, in the case of using the plurality of temperature sensors 150, the time interval of the selection phase or the white selection voltage may also be switched by using a highest one or a lowest one of detected temperatures.

The entire disclosure of Japanese Patent Application No. 2007-086776, filed Mar. 29, 2007 is expressly incorporated by reference herein.

What is claimed is:

1. A display driving device for driving a display device having a plurality of display pixels in which a plurality of scanning electrodes and a plurality of data electrodes are provided so as to overlap and correspond to each other and each of which has an electro-optical layer to which driving voltages corresponding to a data voltage and a scanning voltage are applied when the scanning voltage is applied to the scanning electrodes and the data voltage is applied to the data electrodes, comprising:
a temperature detecting unit that detects the temperature of the display device;
a selection phase setting unit that sets a time interval of a selection phase, in which a driving voltage for selecting gray-scale levels of the display pixels is applied, to a time interval based on a detected temperature when the detected temperature detected by the temperature detecting unit is less than a predetermined temperature and sets a time interval of the selection phase to a fixed time when the detected temperature is equal to or larger than the predetermined temperature; and
a voltage applying unit that applies the driving voltage to the display pixels at the time interval set by the selection phase setting unit.

2. The display driving device according to claim 1,
wherein in the case of setting a gray-scale level of each of the display pixels to an intermediate gray-scale level between a first gray-scale level and a second gray-scale level, the voltage applying unit applies a driving voltage corresponding to the intermediate gray-scale level to the display pixels by controlling an application period of a first driving voltage and an application period of a second driving voltage when one of the first driving voltage, which sets each of the display pixels to the first gray-scale level, and the second driving voltage, which sets each of the display pixels to the second gray-scale level, is applied and then the other voltage is applied in the selection phase.

3. The display driving device according to claim 1,
wherein the voltage applying unit applies one of a first driving voltage, which sets each of the display pixels to a first gray-scale level, and a second driving voltage, which sets each of the display pixels to a second gray-scale level, to each of the display pixels by controlling a voltage of the scanning electrodes and a voltage of the data electrodes on the basis of data designating a gray-scale level of the display pixels when the detected temperature is less than a predetermined temperature and applies one of the first driving voltage, which sets a gray-scale level of each of the display pixels to the first gray-scale level, and a third driving voltage, which is a voltage for setting a gray-scale level of each of the display pixels to the second gray-scale level and is higher than the second driving voltage, to each of the display pixels by controlling a voltage of the scanning electrodes and a voltage of the data electrodes on the basis of data designating a gray-scale level of the display pixels when the detected temperature is equal to or larger than the predetermined temperature.

4. The display driving device according to claim 3,
wherein the voltage applying unit changes the third driving voltage by controlling the voltage of the scanning electrodes and the voltage of the data electrodes on the basis of the detected temperature when the detected temperature is equal to or larger than a predetermined temperature.

5. The display driving device according to claim 3,
wherein the voltage applying unit applies one of a fourth driving voltage, which is a voltage for setting a gray-scale level of each of the display pixels to a first gray-scale level and is higher than the first voltage, and the third driving voltage, which is a voltage for setting a gray-scale level of each of the display pixels to the second gray-scale level and is higher than the second driving voltage, to each of the display pixels by controlling a voltage of the scanning electrodes and a voltage of the data electrodes on the basis of data designating a gray-scale level of the display pixels when the detected temperature is equal to or larger than a predetermined temperature.

6. The display driving device according to claim 5,
wherein when the detected temperature is equal to or larger than a predetermined temperature, the voltage applying unit changes the third driving voltage by controlling a voltage of the scanning electrodes and a voltage of the data electrodes according to the detected temperature and changes the fourth driving voltage by controlling the voltage of the scanning electrodes and the voltage of the data electrodes according to the detected temperature.

7. The display driving device according to claim 6,
wherein in the case of setting a gray-scale level of each of the display pixels to an intermediate gray-scale level between the first gray-scale level and the second gray-scale level, the voltage applying unit applies a driving voltage between the third driving voltage and the fourth driving voltage corresponding to the gray-scale level by controlling a voltage of the scanning electrodes and a voltage of the data electrodes on the basis of data designating a gray-scale level of the display pixels when the detected temperature is equal to or larger than a predetermined temperature.

8. A display device comprising:
a plurality of display pixels in which a plurality of scanning electrodes and a plurality of data electrodes are provided so as to overlap and correspond to each other and each of which has an electro-optical layer to which driving voltages corresponding to a data voltage and a scanning voltage are applied when the scanning voltage is applied to the scanning electrodes and the data voltage is applied to the data electrodes;
a temperature detecting unit that detects the temperature of the display pixels;
a selection phase setting unit that sets a time interval of a selection phase, in which a driving voltage for selecting gray-scale levels of the display pixels is applied, to a time interval based on a detected temperature when the detected temperature detected by the temperature detecting unit is less than a predetermined temperature and sets a time interval of the selection phase to a fixed time when the detected temperature is equal to or larger than the predetermined temperature; and
a voltage applying unit that applies the driving voltage to the display pixels at the time interval set by the selection phase setting unit.

9. An electronic apparatus having the display device comprising;
a plurality of display pixels in which a plurality of scanning electrodes and a plurality of data electrodes are provided so as to overlap and correspond to each other and each of which has an electro-optical layer to which driving voltages corresponding to a data voltage and a scanning voltage are applied when the scanning voltage is applied to the scanning electrodes and the data voltage is applied to the data electrodes;
a temperature detecting unit that detects the temperature of the display pixels;
a selection phase setting unit that sets a time interval of a selection phase, in which a driving voltage for selecting gray-scale levels of the display pixels is applied, to a time interval based on a detected temperature when the detected temperature detected by the temperature detecting unit is less than a predetermined temperature and sets a time interval of the selection phase to a fixed time when the detected temperature is equal to or larger than the predetermined temperature; and
a voltage applying unit that applies the driving voltage to the display pixels at the time interval set by the selection phase setting unit.
